(19) United States
(12) Patent Application Publication
(10) Pub. No.: US 2013/0218757 A1
(43) Pub. Date: Aug. 22, 2013

(54) PAYMENTS USING A RECIPIENT PHOTOGRAPH

(71) Applicants: Dharani Ramanathan, Santa Clara, CA (US); Wesley Hsu, Fremont, CA (US)

(72) Inventors: Dharani Ramanathan, Santa Clara, CA (US); Wesley Hsu, Fremont, CA (US)

(21) Appl. No.: 13/768,485

(22) Filed: Feb. 15, 2013

Related U.S. Application Data
(60) Provisional application No. 61/599,720, filed on Feb. 16, 2012.

(51) Int. Cl. G06Q 20/38

(52) U.S. Cl. CPC G06Q 20/385
USPC 705/39

(57) ABSTRACT

A user takes a photo of a payment recipient using the user's mobile device. The photo is analyzed to determine whether a matching photo with an identifier exists, such as on the user device or within a payment provider database. If so, the identifier is used to identify the recipient and process a payment from the user to the recipient.

### CROSS REFERENCE TO RELATED APPLICATION

This application claims priority to U.S. Provisional Patent Appl. Ser. No. 61/599,720, filed Feb. 16, 2012, which is incorporated by reference in its entirety.

### BACKGROUND

1. Field of the Invention

The present invention is related generally mobile payments and in particular to selecting a recipient for a mobile payment.

2. Description of Related Art

Mobile devices, such as smart phones, are being used for things well beyond simple phone calls between two people. Smart phones enable a user to access the Internet, store content, take photos and videos, and conduct financial transactions.

Typically, with financial transactions, users or senders need to identify a recipient for a payment, which can be a merchant, seller, friend, family member, or charity organization. Generally, a user is required to enter a recipient identifier, such as a mobile number or an email address, so that a payment provider can locate an account of the recipient to process the payment from the sender.

However, with the smaller displays and keyboards/keypads associated with mobile devices, such as smart phones, it can be difficult and burdensome to enter such identifiers, especially long email addresses.

Therefore, there is a need for a user to more easily identify a payment recipient on a mobile device.

### BRIEF DESCRIPTION OF THE DRAWINGS

FIG. 1 is a flowchart of a method for selecting a payment recipient using a photo according to one embodiment;

FIG. 2 is block diagram of a networked system suitable for implementing the processes described herein according to an embodiment; and

FIG. 3 is a block diagram of a computer system suitable for implementing one or more components in FIG. 3 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to one embodiment of the present invention, a user or a sender of money takes a photograph of a payment recipient using the user's mobile device, such as a smart phone or computing tablet. The photo is then processed, such as by the mobile device through a payment provider mobile app, to locate an email address, mobile phone number, or other recipient identifier associated with the photo. In one embodiment, the mobile device may first search the user's contact list, either on the mobile device or other storage area/device, such as in a cloud. If the photo matches a photo from the user's contact list and the contact list includes an acceptable identifier, the user may be asked to confirm the identifier is the desired recipient identifier. Upon confirmation, the payment can be processed through the mobile device, such as through a mobile app on the user mobile device.

However, if no photo match is found in a user contact list, the photo may be sent to the payment provider, who then searches a database or cloud to determine whether the photo matches any recipient account with the payment provider. If a match is found, the user may be asked to confirm the identifier. Upon confirmation, the payment can be processed.

If no photo is found by the payment provider, the user may be asked to enter a recipient identifier, such as through conventional means, e.g., using text or voice, to enter an email address, mobile phone number, or the like. The identifier and photo are then associated and saved so that a subsequent payment request using a photo of the recipient can be found and processed.

As such, a user may quickly and easily complete a payment without having to manually enter an identifier if the recipient has a photo associated with the identifier stored in the user's mobile device, with the payment provider, or other accessible storage.

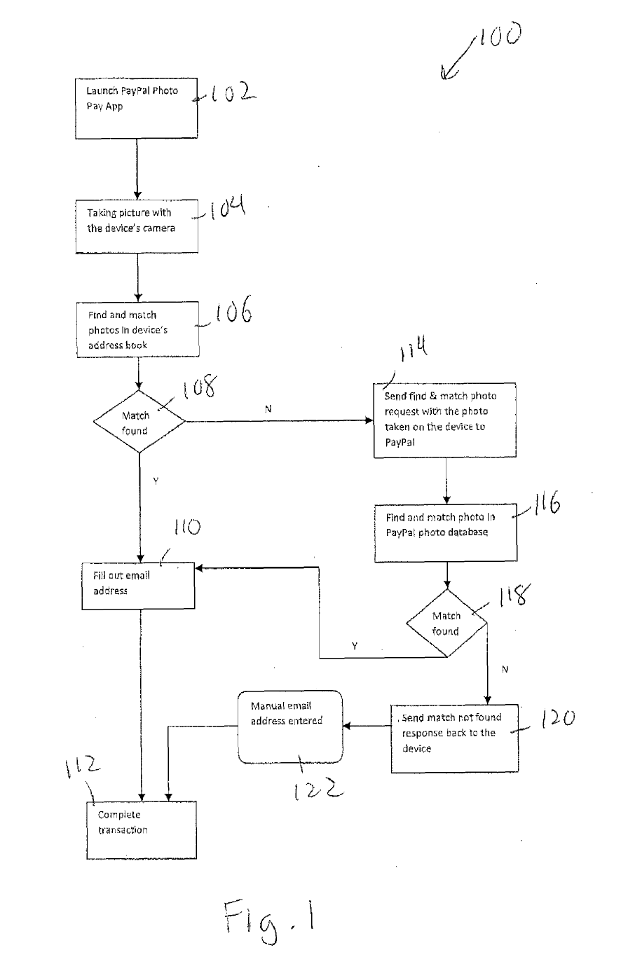

FIG. 1 is a flowchart of a method 100 for selecting a payment recipient using a photo according to one embodiment. At step 102, a user launches a payment provider app on the user's mobile device, such as a smart phone or tablet. The user may simply tap the app to launch. The service may be initiated in other ways as well, such as through a mobile browser accessing a URL or website of the payment provider. The payment provider may be a third party payment provider service, such as PayPal, Inc. of San Jose, Calif., or other service provider. Once launched or at the desired page/screen, the user may need to be authenticated if not already authenticated. For example, the user may be requested to enter a user identifier, such as a user name, email address, or mobile phone number, and a password or PIN. If the device “remembers” the user, the user identifier information may be pre-filled so that only the PIN or password would need to be entered.

Once authenticated, the user may see a home screen for user's account with the payment provider. The home screen may include an option to send money to a recipient, which may be selectable by the user through a tap, click, or other means. Once selected, the user may be asked to enter or select a payment amount. The user may enter a payment amount through a keypad, voice, or other input means, or the user may select an amount from a drop down list. The user may also be asked to identify the intended recipient of the payment. It is at this point that the user typically has to manually enter an email address or phone number of the recipient.

However, with the present embodiment, the user can, instead, take a picture of the recipient, at step 104, with a camera on the user's mobile device. The display may set boundaries or provide other suggestions of how to frame the recipient's face. For example, a certain size photo of the face may be required, such that the user may need to move closer or farther from the recipient and/or zoom in or out with the device camera. Once an acceptable photo is taken, the user may store, submit, or otherwise have the photo used for the payment process. In one embodiment, the user selects a “Use” button or link to select. The user may also retake the photo as desired.

Once a photo is selected for use, the photo is processed, at step 106, to determine whether a matching photo exists in the device contact or address book. In one embodiment, this processing is done locally through the user's mobile device. The photo may be analyzed using known facial detection and recognition techniques. A facial recognition algorithm may be applied to the photo to extract one or more features or landmarks from it. The feature(s) and/or landmark(s) can then be used to do a similarity matching. For example, a feature or landmark may be first obtained from the photo taken. The feature or landmark can be stored in memory on the device for the matching process. In one embodiment, a database of features or landmarks for photos is present in the device or may be created. The matching process then compares the feature(s) or landmark(s) in the memory with the ones in the database.

If the device does not have memory storing or containing such a features/landmarks database, the facial recognition and detection process may happen in real time for both the photo taken and photos in device address books. Feature(s) and/or landmark(s) extracted from the photo taken may still be stored in memory. In this case, the facial recognition system works on the photos in the address book one by one and compares it with the one in memory until or if a match is found, e.g., sequential analysis of photos.

The situation may arise where no match is found. One reason for this may be that a user contact does not have a photo associated with it. Another reason may be that the photo was not taken correctly and/or that the photo associated with the desired recipient cannot be matched to the taken photo, such as if one or both photos are too small, at certain angles, too dark, etc. If no exact match is found, the user may still be provided some contacts having similar photos, but not similar enough to warrant a match. The user may then have the option of selecting an intended recipient from the one or more “similar” photos to the one taken by the user.

If a match is found (or the user selects a similar photo), at step 108, the email, mobile phone number, or other identifier associated with the matched or selected photo is used to identify the recipient. Note that if a photo is found, but no suitable identifier is found, the user may be asked to enter a specific identifier, such as an email address or phone number, for the photo. The device address book or contact list can be then updated to include the identifier.

Once the identifier is available, in one embodiment, the user payment screen on the mobile device may be automatically filled, at step 110, with the recipient email address or other identifier, such as a mobile phone number. The user may then be asked to confirm the displayed recipient identifier is the desired or intended one. If the recipient identifier is not for the intended recipient, the user may manually enter the desired identifier, such as by text or voice.

If the displayed recipient information is correct, the payment transaction can be completed at step 112. This may include debiting a payment amount (including any fees) from a user account and crediting a payment amount to a recipient account with the payment provider. Note that if the recipient does not have an account with the payment provider, the recipient may receive a notification, either through email, text, or voice, informing the recipient that a payment is waiting and to open an account with the payment provider to receive the payment. Once the payment process is completed, the user and/or the recipient may receive a notice that payment has been made.

Referring back to step 108, if no photo in the user's device address book or contact list is found to match the taken photo, the taken photo may be processed, at step 114 by the payment provider. The taken photo may be communicated by the user device to the payment provider, such as to a server, processor, or database, or retrieved by the payment provider, such as from a cloud storage or other accessible data storage.

Next, at step 116, the payment provider searches its database and/or other databases for a matching photo. The process may be similar to step 106 in terms of how a photo is matched. The payment provider database may include account information for all its users, although not all accounts may have a corresponding photo. So, even though a desired recipient has an account with the payment provider, a matching photo may not be located. The payment provider may also search third party sources or other publicly available sources for a matching photo. Examples include a social network, which typically has user photos along with user contact information, such as emails and phone numbers.

If a matching photo is found (or a similar photo is selected by the user), as determined at step 118, the recipient identifier is retrieved and the payment is processed, similar to steps 110 and 112. Note that the user's address book or contact list may be updated by the payment provider to include the recipient's identifier.

However, if step 118 determines that no matching photo is found, such that the payment provider is unable to determine a suitable recipient identifier from the taken photo, the user is notified, at step 120. Notification may also include a request for the user to manually enter a recipient identifier. For example, the user may see a field on the user device to enter an email address or mobile phone number of the recipient.

The user then enters the requested identifier at step 122, such as by voice, text, or other means. Once entered, the payment is processed at step 112. If an identifier is not associated with a stored photo (such as in the user address book/contact list or a payment provider database), the identifier may be stored for future use. If an identifier does not have a stored photo associated with it, the taken photo may be added to the user address book/contact list and/or the payment provider database so that a photo is now associated with an identifier. As a result, future payment transactions may be more efficient for the user.

Note that one or more steps above may be performed in a different sequence, combined, or omitted as desired. For example, after the photo is taken at step 104, the photo may be processed to determine a match simultaneously by searching the user device contact list/address book, the payment provider data base, and any other data source, such as a social network.

Thus, as described above, a user can quickly and easily send a payment to a recipient by simply taking a photo of the recipient. If an appropriate recipient identifier cannot be found from the photo, one or more devices or databases can be updated or revised to include the needed information for subsequent payments to the same recipient using a photo.

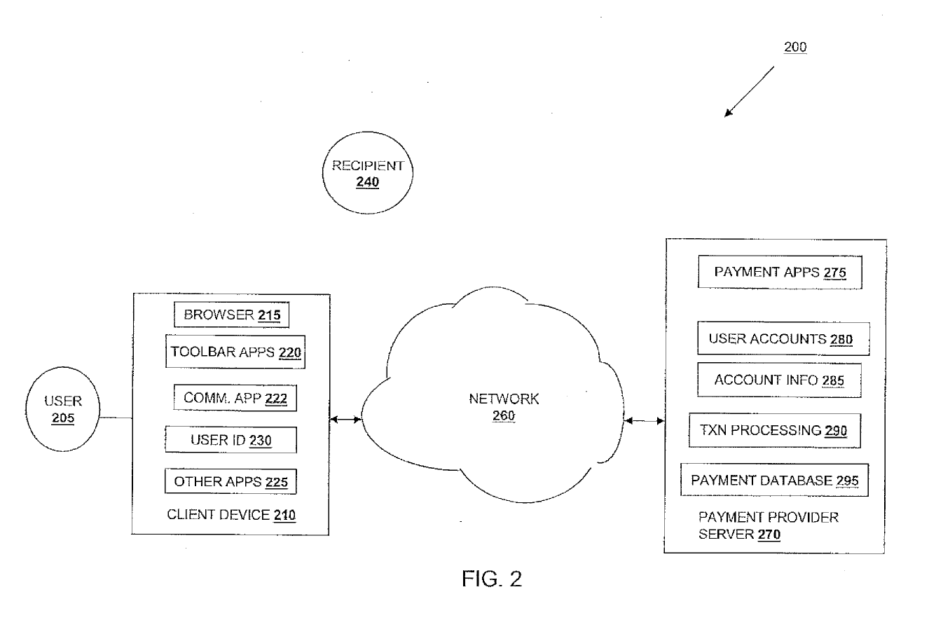

FIG. 2 is a block diagram of a networked system 200 configured to handle a financial transaction between a payment recipient and a payment sender (e.g., user or consumer), such as described above, in accordance with an embodiment of the invention. System 200 includes a user device 210, a recipient 240, and a payment provider server 270 in communication over a network 360. Payment provider server 270 may be maintained by a payment provider, such as PayPal, Inc. of San Jose, Calif.. A user 205, such as the sender or consumer, utilizes user device 210 to perform a payment transaction (e.g., sending funds) with recipient 240 using payment provider server 270.

User device 210 and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260. Furthermore, user device 210 may include a camera for capturing an image of recipient 240.

Network 260 may be implemented as a single network or a combination of multiple networks. For example, in various embodiments, network 260 may include the Internet or one or more intranets, landline networks, wireless networks, and/or other appropriate types of networks.

User device 210 may be implemented using any appropriate hardware and software configured for wired and/or wireless communication over network 260. For example, in one embodiment, the user device may be implemented as a camera-equipped smart phone, personal digital assistant (FDA), laptop computer, PC, and/or other types of computing devices capable of transmitting and/or receiving data, such as a computing tablet.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet or access a website of the payment provider. User device 210 may also include one or more toolbar applications 220 which may be used, for example, to provide client-side processing for performing desired tasks in response to operations selected by user 205, such as transfer or send money to a recipient. In one embodiment, toolbar application 220 may display a user interface in connection with browser application 215.

User device 210 may further include other applications 225, such as mobile Apps, as may be desired in particular embodiments to provide desired features to user device 210. For example, other applications 225 may include security applications for implementing client-side security features, programmatic client applications for interfacing with appropriate application programming interfaces (APIs) over network 260, or other types of applications. Applications 225 may also include apps for email, texting, voice and IM applications that allow user 205 to send and receive emails, calls, and texts through network 260, as well as applications or apps that enable the user to communicate, place orders, and make payments through the payment provider as discussed above. User device 210 includes one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider as further described herein. A communications application 222, with associated interfaces, enables user device 210 to communicate within system 200.

User device 210 may also include an application for facial recognition that enables a taken photo to be searched and analyzed for matching or similar photos stored on the device and associated with known user contacts, as described herein.

Payment provider server 270 may be maintained, for example, by an online payment service provider which may provide payment between user 205 and recipient 240. Recipient 240 may also have a consumer device that has an associated recipient identifier like a mobile phone number and/or an email address through an email service provider. Payment provider server 270 may also include one or more payment applications 275 which may be configured to interact with user device 210 over network 260 to facilitate a financial transaction for user 205, such as a payment to recipient 240.

Payment provider server 270 also maintains a plurality of user accounts 280, each of which may include account information 285 associated with individual users and merchants. For example, account information 285 may include private financial information of users of devices such as account numbers, passwords, device identifiers, user names, phone numbers, credit card information, bank information, user photos, or other financial information which may be used to facilitate online transactions by user 205.

A transaction processing application 290, which may be part of payment application 275 or separate, may be configured to receive information from user device 210 for processing and storage in a payment database 295. Transaction processing application 290 may include one or more applications to process information from user 205 for processing a payment from the user through a user device while on a website or app as described herein. As such, transaction processing application 290 may search for matching or similar photos associated with user accounts from a received photo from user 205 through user device 210. Payment application 275 may be further configured to determine the existence of and to manage accounts for user 205, as well as create new accounts if necessary, such as the set up, management, and use of photos and identifiers.

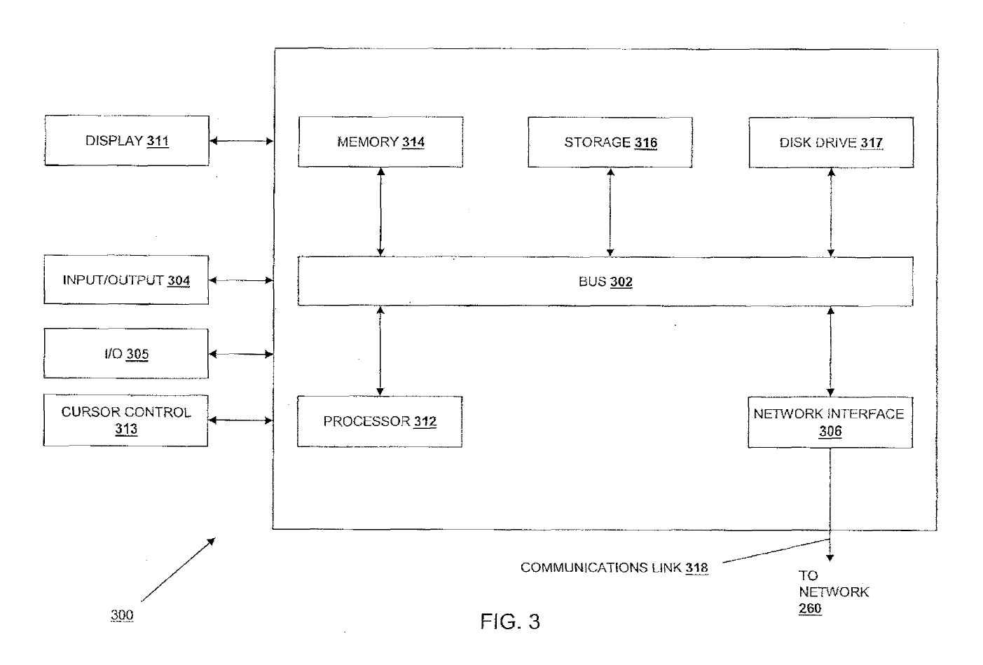

FIG. 3 is a block diagram of a computer system 300 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). An input/output component 305, such as a camera, may also be included to allow a user to capture images or take photos, such as of recipient 240. A voice I/O component, not shown, may enable the user to use voice for inputting information by converting audio signals. The audio I/O component may allow the user to hear audio. A transceiver or network interface 306 transmits and receives signals between computer system 300 and other devices, such as another user device, a merchant server, or a payment provider server via network 360. In one embodiment, the transmission is wireless, although other transmission mediums and methods may also be suitable. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314, such as matching a received photo with stored photos. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A system comprising:
a memory storing account information for a plurality of users, wherein the account information comprises a user identifier and a photo of a user;
one or more hardware processors in communication with the memory and operable for:
receiving a photo of a recipient from a user device;
determining whether the photo matches a photo associated with an account holder with a payment provider;
retrieving a user identifier based on the photo if a match is found; and
processing a payment request to the recipient.

2. The system of claim 1, wherein the determining comprises searching the memory.

3. The system of claim 1, wherein the determining comprises searching a third party database.

4. The system of claim 1, wherein the determining comprises searching an address book in the user device.

5. The system of claim 1, wherein the photo is taken by the user device.

6. The system of claim 1, wherein the one or more processors is further operable for updating the memory to include the photo of the recipient if no match was found and the recipient has an account with the payment provider.

7. The system of claim 1, wherein the one or more processors is further operable for automatically filling in the user identifier on the user device.

8. The system of claim 1, wherein the user identifier is an email address or a phone number.

9. A method for performing a payment transaction, comprising:
receiving, electronically by a hardware processor of a payment provider, a photo of a recipient from a user device;
determining, by the processor, whether the photo matches a photo associated with an account holder with the payment provider;
retrieving, by the processor, a user identifier based on the photo if a match is found; and
processing a payment request to the recipient.

10. The method of claim 9, wherein the determining comprises searching the memory.

11. The method of claim 9, wherein the determining comprises searching a third party database.

12. The method of claim 9, wherein the determining comprises searching an address book in the user device.

13. The method of claim 9, wherein the photo is taken by the user device.

14. The method of claim 9, further comprising updating the memory to include the photo of the recipient if no match was found and the recipient has an account with the payment provider.

15. The method of claim 9, further comprising automatically filling in the user identifier on the user device.

16. The method of claim 9, wherein the user identifier is an email address or phone number.

17. A non-transitory machine-readable medium comprising a plurality of machine-readable instructions which when executed by one or more processors of a server are adapted to cause the server to perform a method comprising:
receiving, by a payment provider, a photo of a recipient from a user device;
determining whether the photo matches a photo associated with an account holder with the payment provider;
retrieving a user identifier based on the photo if a match is found; and
processing a payment request to the recipient.

18. The non-transitory machine-readable medium of claim 17, wherein the determining comprises searching the memory.

19. The non-transitory machine-readable medium of claim 17, wherein the determining comprises searching a third party database.

20. The non-transitory machine-readable medium of claim 17, wherein the determining comprises searching an address book in the user device.

21. The non-transitory machine-readable medium of claim 17, wherein the photo is taken by the user device.

22. The non-transitory machine-readable medium of claim 17, wherein the method further comprises updating the memory to include the photo of the recipient if no match was found and the recipient has an account with the payment provider.

23. The non-transitory machine-readable medium of claim 17, wherein the method further comprises automatically filling in the user identifier on the user device.

24. The non-transitory machine-readable medium of claim 17, wherein the user identifier is an email address or phone number.
